(19) United States
(12) Patent Application Publication
(10) Pub. No.: US 2026/0104336 A1
(43) Pub. Date: Apr. 16, 2026

(54) CHARPY IMPACT SPECIMEN NOTCH INSPECTOR AND USE METHOD THEREOF

(71) Applicant: Guangzhou Keyuan Industry Equipment Installation Inspection & Testing Technology Co., Ltd., Guangzhou (CN)

(72) Inventors: Liang XU, Guangzhou (CN); Bingliang CAO, Guangzhou (CN); Zhihui LAN, Guangzhou (CN); Wanna LIN, Guangzhou (CN); Jiabing LI, Guangzhou (CN); Caimeng LIANG, Guangzhou (CN); Rongsheng ZHANG, Guangzhou (CN); Junzi WANG, Guangzhou (CN); Shaoquan WU, Guangzhou (CN); Xin ZHANG, Guangzhou (CN); Fenbi YI, Guangzhou (CN); Chunnan QIAO, Guangzhou (CN); Guangkai WU, Guangzhou (CN)

(73) Assignee: Guangzhou Keyuan Industry Equipment Installation Inspection & Testing Technology Co., Ltd., Guangzhou (CN)

(21) Appl. No.: 19/280,848

(22) Filed: Jul. 25, 2025

(30) Foreign Application Priority Data
Oct. 15, 2024 (CN) 202411439021.3

(51) Int. Cl. G01N 3/04; G01N 3/30

(52) U.S. Cl. CPC G01N 3/04; G01N 3/30; G01N 2203/001; G01N 2203/0098; G01N 2203/0647

(57) ABSTRACT

Provided is a Charpy impact specimen notch inspector and a use method thereof. The Charpy impact specimen notch inspector includes an inspection table, where a specimen auto-alignment mechanism is provided on a top of the inspection table; a support rod is fixedly connected to a rear side of the top of the inspection table; a host is fixedly connected to a front side of the support rod; and a switch button and a universal serial bus (USB) interface are provided at a left side of the host. This application can automatically recognize and align the position of the to-be-inspected Charpy impact specimen, without adjusting the Charpy impact specimen back and forth, thereby improving the inspection efficiency. Moreover, this application can directly compare the notch picture of the Charpy impact specimen with the corresponding standard model based on the residual neural network in inspection to determine whether the notch is qualified.

### CROSS REFERENCE TO RELATED APPLICATION

This patent application claims the benefit and priority of Chinese Patent Application No. 202411439021.3, filed with the China National Intellectual Property Administration on Oct. 15, 2024 entitled Charpy Impact Specimen Notch Inspector And Use Method Thereof, the disclosure of which is incorporated by reference herein in its entirety as part of the present application.

### TECHNICAL FIELD

The present disclosure relates to the technical field of Charpy impact specimen notch inspection, in particular to a Charpy impact specimen notch inspector and a use method thereof.

### BACKGROUND

Inspection after V&U-notching of Charpy impact specimens is mainly intended to check whether the V&U-notching complies with requirements of the inspection standard. It is directly associated with the accuracy of the Charpy impact test result. Any unqualified notches cannot be used for the test. The inspection is an essential step before the test is started. As the commonly used V&U-notch inspector at present, the impact specimen notch projector has the following principle: The V-notch and the U-notch are magnified by 50 times through two objective lenses. Then, contours of the V-notch and the U-notch are respectively compared with contours of standard V-notch and U-notch manufactured according to an allowable tolerance of the inspection standard on the projection screen. If the comparison result falls within the range of the inspection standard, the notching is qualified; otherwise, the notching is unqualified.

The inspection method using the projector in the prior art has the following defects: 1. The inspection efficiency is low. When the notch is inspected, the specimen is adjusted through left-right and front-back movement on a worktable, so as to align at a standard template on the projection screen. 2. One impact specimen notch projector is usually only provided with the standard template of one inspection standard. For example, it can only be provided with the Guobiao (GB, Chinese national standard)-compliant standard template. If the American Society for Testing Material (ASTM) standard is required for inspection in the test, another notch projector is provided, or the standard notch template is replaced. Frequent replacement of the standard notch template affects the inspection efficiency and is very inconvenient. Therefore, the present disclosure provides a Charpy impact specimen notch inspector and a use method thereof.

### SUMMARY

In view of the technical problem in the background, the present disclosure provides a Charpy impact specimen notch inspector and a use method thereof.

The present disclosure provides a Charpy impact specimen notch inspector, including an inspection table, where a specimen auto-alignment mechanism is provided on a top of the inspection table; a support rod is fixedly connected to a rear side of the top of the inspection table; a host is fixedly connected to a front side of the support rod; a switch button and a universal serial bus (USB) interface are provided at a left side of the host; a touchscreen is provided on a top of the host; and an autofocus high-definition camera is fixedly provided at a bottom of the host; and

the host includes an image data preprocessing module, an image storage module, an image processing module, an image recognizing and computing module, a programmable logic controller (PLC) unit, and a battery module; the image storage module is connected to the autofocus high-definition camera, the USB interface, and the image data preprocessing module; the image data preprocessing module is connected to the image processing module and the image recognizing and computing module; the PLC unit is connected to the image recognizing and computing module and the autofocus high-definition camera; and the image processing module is connected to the touchscreen.

Preferably, the specimen auto-alignment mechanism includes a specimen placement table in movable contact with the top of the inspection table; a mounting groove is formed in the top of the inspection table; a cross-shaped electric sliding rail is fixedly connected to a bottom inner wall of the mounting groove; a brake motor is fixedly connected to a top of a sliding end of the cross-shaped electric sliding rail; a top end of an output shaft of the brake motor is fixedly connected to a bottom of the specimen placement table; and both the cross-shaped electric sliding rail and the brake motor are electrically connected to the PLC unit.

Preferably, the battery module is configured to supply power to the host; the autofocus high-definition camera is configured to compare a picture of a notch of a Charpy impact specimen, with a captured notch picture stored by the image storage module; and the image data preprocessing module is configured to perform data preprocessing of noise reduction and filtering on the stored notch picture, and further configured to perform brightness adjustment and contrast enhancement, thereby improving an image resolution, and preventing an undue error caused by a hardware factor. In response to the brightness adjustment and the contrast enhancement, a parameter of the captured notch picture is adjusted to a preset parameter, such that brightness and contrast of the image are adjusted, thereby improving a subsequent comparison accuracy.

Preferably, a GB-compliant V&U-notch standard template and an ASTM-compliant V&U-notch standard template are stored in the image processing module; a desired standard model may be selected through the touchscreen; and the image processing module is configured to compare a picture of a notch captured by the autofocus high-definition camera with the selected standard model using a residual neural network (ResNet) to determine whether the notch is qualified; and
the ResNet needs to be trained in advance to form a network, with an accuracy determined by a test set; and the ResNet is formed specifically as follows:
(1) acquiring Charpy impact specimen images in different states, including a notched sample, an unnotched sample, and samples with different notch types and sizes, labeling each specimen image with a notch state and a corresponding class, adjusting the specimen image to a uniform size (224×224 pixels) to meet an input requirement of a common ResNet, scaling a pixel value to an interval [0, 1], and expanding a dataset with data augmentation (such as rotation, translation, flipping, and color adjustment);
(2) partitioning an expanded dataset into a training set (70%), a validation set (15%), and the test set (15%), and ensuring that samples in each set are sufficient and representative;
(3) according to a sample complexity and a computing resource, selecting an appropriate version of ResNet (ResNet-50 and ResNet-101), constructing a network including a plurality of residual blocks, each residual block including a convolutional layer, batch normalization, and a rectified linear unit (ReLU) activation function, and setting an initial value for a weight of the network with a He initialization method;
(4) inputting the samples in the training set to the selected version of ResNet, computing an output, computing a loss according to an output result and a ground truth label, computing a gradient of the loss on each parameter with a back propagation algorithm, and updating the weight with an optimization algorithm;
(5) evaluating performance of a model on the validation set, monitoring an accuracy rate and a loss of the model to prevent overfitting, testing the model with an unseen dataset to evaluate metrics including an accuracy, a recall rate, and an F1-score, and adjusting a parameter of the model according to the metrics, thereby obtaining a well-trained ResNet; and
(6) deploying the well-trained ResNet to an actual application, and inspecting the notch of the Charpy impact specimen with the ResNet.

Preferably, the image recognizing and computing module is configured to recognize the specimen notch picture captured by the autofocus high-definition camera, and determine whether a position of the notch in the picture is offset; and if yes, the cross-shaped electric sliding rail is controlled by the PLC unit, with the sliding end adjusting a front position, a rear position, a left position and a right position of the specimen placement table, thereby adjusting a position of the Charpy impact specimen to align the Charpy impact specimen.

Preferably, the USB interface is connected to an external storage device, and configured to transmit data stored in the image storage module to the external storage device.

The present disclosure further provides a use method of a Charpy impact specimen notch inspector, including the following steps:
S1: positioning a to-be-inspected Charpy impact specimen horizontally on a top of a specimen placement table;
S2: powering on a host through a switch button, tapping a capturing function on a touchscreen, and activating an autofocus high-definition camera through a PLC unit to compare a notch picture of the Charpy impact specimen on the top of the specimen placement table;
S3: storing the notch picture of the Charpy impact specimen captured in the step S2 to an image storage module, and performing, by an image data preprocessing module, data preprocessing of noise reduction and filtering on a picture stored in the image storage module, and further performing brightness adjustment and contrast enhancement, thereby improving an image resolution;
S4: recognizing, by an image recognizing and computing module, a picture processed in the step S3, and computing an offset for the notch of the Charpy impact specimen in the picture through an offset computing formula, to determine an offset condition of the Charpy impact specimen; and if the Charpy impact specimen is offset, controlling a cross-shaped electric sliding rail and a brake motor through the PLC unit according to the computed offset to drive the specimen placement table for front-back and left-right movement and 360° rotation, such that the specimen placement table drives the Charpy impact specimen on the top of the specimen placement table to move to a preset standard coordinate position;
S5: after the Charpy impact specimen is aligned, selecting a to-be-compared standard model in an image processing module through the touchscreen, where the standard model is any one of a GB-compliant V&U-notch standard template and an ASTM-compliant V&U-notch standard template; and
S6: comparing, by the image processing module, the notch picture of the Charpy impact specimen with a selected standard model based on a well-trained ResNet, computing a similarity to determine whether the notch is qualified, and displaying a result on the touchscreen, thereby completing a work cycle for inspecting the notch of the Charpy impact specimen.

Preferably, in the step S4, computing the offset for the notch of the Charpy impact specimen in the picture through the offset computing formula, to determine the offset condition of the Charpy impact specimen specifically includes:
S401: extracting a feature of an image in the processed picture through the well-trained ResNet, and recognizing a feature point in the image through an image processing algorithm, the feature point including an edge and a midpoint of the notch;
S402: computing a present position coordinate of the notch through a detected key point, predefining a key position coordinate of a standard notch image, and comparing a measured coordinate with a standard notch coordinate to obtain the offset, where the offset is computed by: {offset}=(x1-x2, y1-y2),
where x1 represents a coordinate value of an actual measured position of a notch extracted by the image recognizing and computing module from a present captured specimen image on a horizontal axis (x-axis), y1 represents a coordinate value of the actual measured position of the notch extracted by the image recognizing and computing module from the present captured specimen image on a vertical axis (y-axis), x2 represents a coordinate value of a preset standard notch position on the horizontal axis (x-axis), y2 represents a coordinate value of the preset standard notch position on the vertical axis (y-axis), and {offset} represents a degree of offset of a present measured notch position relative to the standard position; and
S403: setting a reasonable offset threshold as {threshold}={(x_{\{threshold})\hat{ }2+(y_{threshold})\hat{ }2}, comparing an absolute value of a computed offset {offset} with the threshold, and if {offset}>{threshold}, determining that a position of the specimen is offset, otherwise, the position of the specimen is not offset.

Preferably, in the step S6, comparing, by the image processing module, the notch picture of the Charpy impact specimen with the selected standard model based on the well-trained ResNet, to determine whether the notch is qualified specifically includes:
S601: inputting picture data processed by the image data preprocessing module to the well-trained ResNet;
S602: extracting, through the ResNet, a feature of the notch picture in the picture data input in the step S601; and
S603: comparing the feature extracted in the step S602 with a feature of the standard model by computing the similarity, and outputting, through the ResNet, whether the notch is qualified, where the similarity is computed with a cosine similarity by:

$$[ \{ cosine\_similarity \} ( A , B ) = \{ A ∖ cdot B \} \{ \vert A \vert \vert B \vert \} = \{ ∖ sum\_ \{ i = 1 \} \hat{} \{ n \} A\_i B\_i \} \text{} \{ \{ ∖ sum\_ \{ i = 1 \} \hat{} \{ n \} A\_i \hat{} 2 \} \{ ∖ sum\_ \{ i = 1 \} \hat{} \{ n \} B\_i \hat{} 2 \} \} ] ,$$

where A and B are respectively two eigenvectors to be compared, A\cdotB is a dot product of the two eigenvectors, |A| and |B| are respectively norms of the eigenvectors, an output value of the cosine similarity is between −1 and 1, and a value closer to 1 indicates a higher similarity between the two eigenvectors.

Compared with the prior art, the present disclosure has the following beneficial effects:
1. In combination with the image recognizing and computing module, and the specimen auto-alignment mechanism, the present disclosure can recognize and determine the offset condition of the positioned Charpy impact specimen by computing the offset, and automatically align the Charpy impact specimen to the standard coordinate position when the Charpy impact specimen is offset. This improves the inspection efficiency, without adjusting the Charpy impact specimen back and forth.

2. In cooperation with the image data preprocessing module and the image processing module, the present disclosure can store the GB-compliant V&U-notch standard template and the ASTM-compliant V&U-notch standard template to the image processing module at the same time, and compare the notch picture of the Charpy impact specimen with the corresponding standard model directly based on the ResNet to determine whether the notch is qualified. Such a direct selecting and comparing method can meet different notch inspection requirements, without frequently changing the standard notch template, thereby improving the application range, and omitting the operating steps.

The present disclosure can automatically recognize and align the position of the to-be-inspected Charpy impact specimen, without adjusting the Charpy impact specimen back and forth, thereby improving the inspection efficiency. Moreover, the present disclosure can directly compare the notch picture of the Charpy impact specimen with the corresponding standard model based on the ResNet in inspection to determine whether the notch is qualified. Such a direct selecting and comparing method can meet different notch inspection requirements, without frequently changing the standard notch template, thereby omitting the operating steps, and further improving the inspection efficiency.

### BRIEF DESCRIPTION OF THE DRAWINGS

FIG. 1 is a schematic structural view of a Charpy impact specimen notch inspector according to the present disclosure;

FIG. 2 is a schematic structural view of a state in which a specimen placement table in a Charpy impact specimen notch inspector is not provided according to the present disclosure;

FIG. 3 is a block diagram of a connection of an autofocus high-definition camera, a host and a cross-shaped electric sliding rail in a Charpy impact specimen notch inspector according to the present disclosure;

FIG. 4 is a schematic view of a GB-compliant V&U-notch standard template in a use method of a Charpy impact specimen notch inspector according to the present disclosure; and

FIG. 5 is a schematic view of an ASTM-compliant V&U-notch standard template in a use method of a Charpy impact specimen notch inspector according to the present disclosure.

In the figures: 1: inspection table, 2: support rod, 3: host, 301: touchscreen, 302: switch button, 303: USB interface, 4: autofocus high-definition camera, 5: specimen placement table, 6: cross-shaped electric sliding rail, 601: sliding end, and 7: brake motor.

### DETAILED DESCRIPTION OF THE EMBODIMENTS

The present disclosure will be further described below with reference to specific embodiments.

### Embodiment

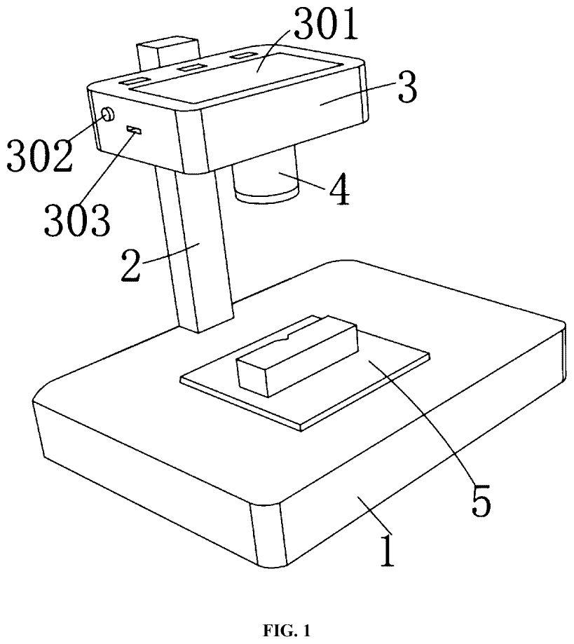

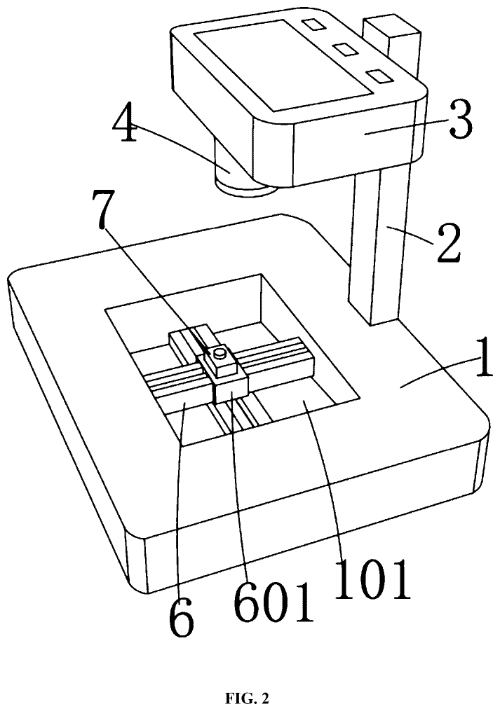

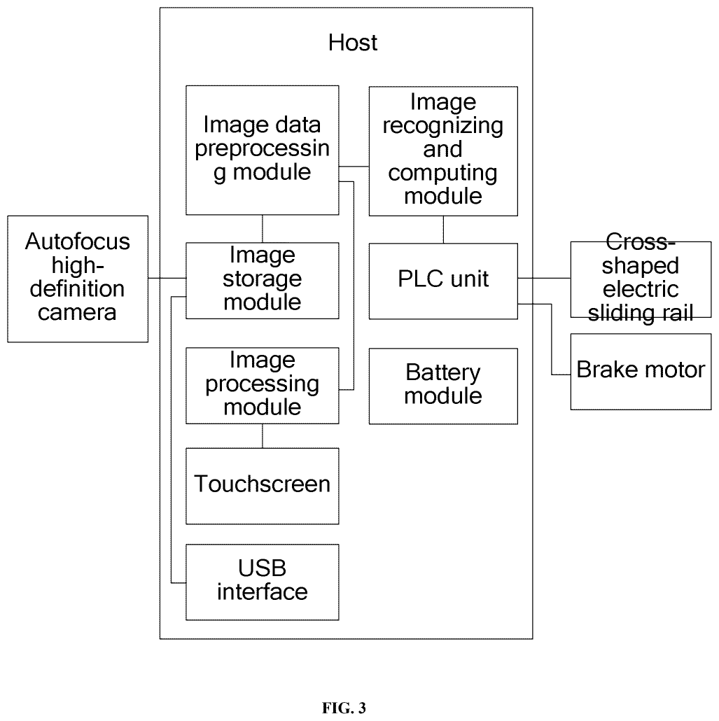

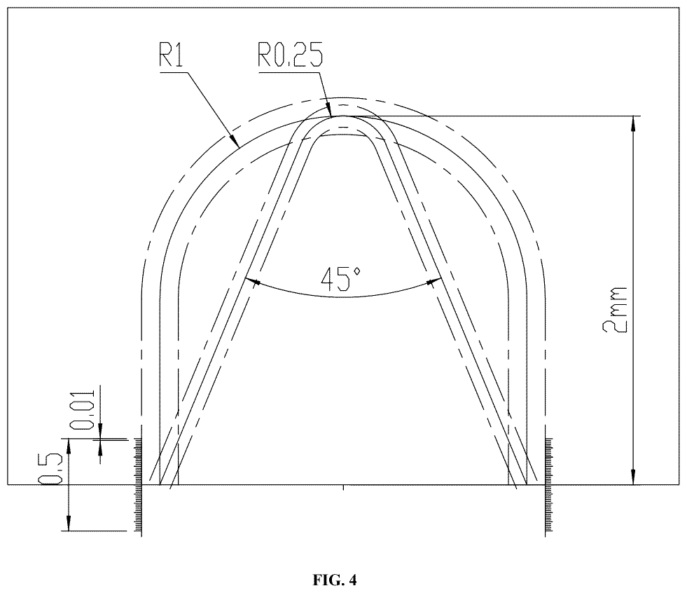

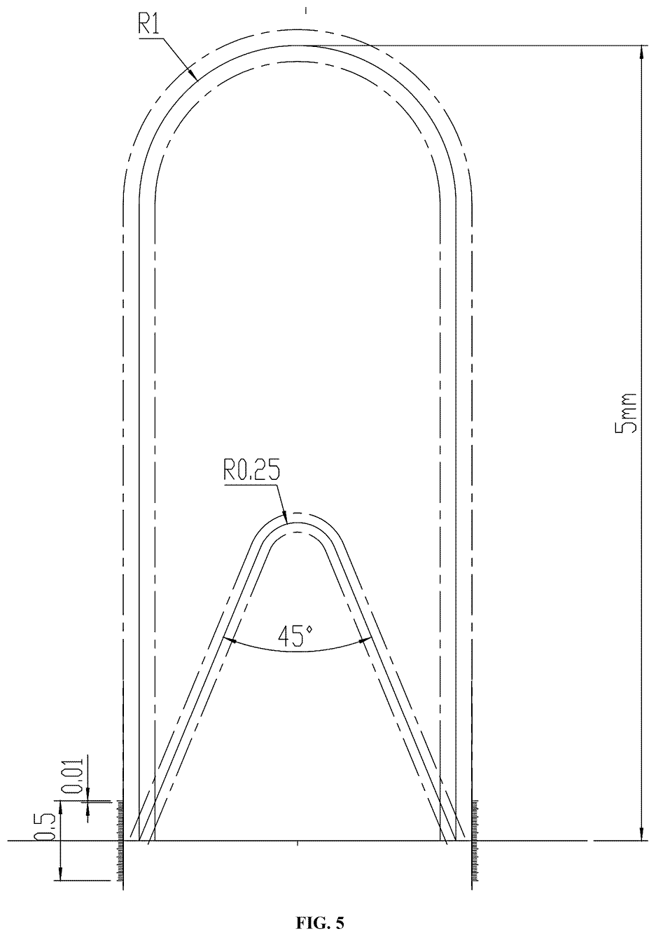

Referring to FIGS. 1-5, the embodiment provides a Charpy impact specimen notch inspector, including an inspection table 1. A specimen auto-alignment mechanism is provided on a top of the inspection table 1.

The specimen auto-alignment mechanism includes a specimen placement table 5 in movable contact with the top of the inspection table 1. A mounting groove 101 is formed in the top of the inspection table 1. A cross-shaped electric sliding rail 6 is fixedly connected to a bottom inner wall of the mounting groove 101. A brake motor 7 is fixedly connected to a top of a sliding end 601 of the cross-shaped electric sliding rail 6. A top end of an output shaft of the brake motor 7 is fixedly connected to a bottom of the specimen placement table 5.

A support rod 2 is fixedly connected to a rear side of the top of the inspection table 1. A host 3 is fixedly connected to a front side of the support rod 2. A switch button 302 and a USB interface 303 are provided at a left side of the host 3. A touchscreen 301 is provided on a top of the host 3. An autofocus high-definition camera 4 is fixedly provided at a bottom of the host 3.

The host 3 includes an image data preprocessing module, an image storage module, an image processing module, an image recognizing and computing module, a PLC unit, and a battery module. The image storage module is connected to the autofocus high-definition camera 4, the USB interface 303, and the image data preprocessing module. The image data preprocessing module is connected to the image processing module and the image recognizing and computing module. The PLC unit is connected to the image recognizing and computing module and the autofocus high-definition camera 4. The image processing module is connected to the touchscreen 301. Both the cross-shaped electric sliding rail 6 and the brake motor 7 are electrically connected to the PLC unit.

The battery module is configured to supply power to the host 3. The autofocus high-definition camera 4 is configured to compare a picture of a notch of a Charpy impact specimen, with a captured image stored by the image storage module. The USB interface 303 is connected to an external storage device, and configured to transmit data stored in the image storage module to the external storage device. Through storage, the notch inspection data is archived conveniently and the specimen processing is traced conveniently, preventing the shortage that the existing notch projector cannot store the picture.

The image data preprocessing module is configured to perform data preprocessing of noise reduction and filtering on the stored notch picture, and further configured to perform brightness adjustment and contrast enhancement, thereby improving an image resolution, and preventing an undue error caused by a hardware factor.

A GB-compliant V&U-notch standard template and an ASTM-compliant V&U-notch standard template are stored in the image processing module. A desired standard model may be selected through the touchscreen. The image processing module is configured to compare a picture of a notch captured by the autofocus high-definition camera 4 with the selected standard model based on a ResNet to determine whether the notch is qualified.

The ResNet needs to be trained in advance to form a network, with an accuracy determined by a test set. The ResNet is formed specifically as follows:
(1) Charpy impact specimen images in different states, including a notched sample, an unnotched sample, and samples with different notch types and sizes, are acquired. Each specimen image is labeled with a notch state and a corresponding class. The specimen image is adjusted to a uniform size (224×224 pixels) to meet an input requirement of a common ResNet. A pixel value is scaled to an interval [0, 1]. A training set is expanded with data augmentation (such as rotation, translation, flipping, and color adjustment).
(2) An expanded dataset is partitioned into a training set (70%), a validation set (15%), and the test set (15%). It is ensured that samples in each set are sufficient and representative.
(3) According to a sample complexity and a computing resource, an appropriate version of ResNet (ResNet-50 and ResNet-101) is selected, a network including a plurality of residual blocks is constructed. Each residual block includes a convolutional layer, batch normalization, and a ReLU activation function. An initial value is set for a weight of the network with a He initialization method.
(4) The samples in the training set are input to the selected version of ResNet. An output is computed. A loss is computed according to an output result and a ground truth label. A gradient of the loss on each parameter is computed with a back propagation algorithm. The weight is updated with an optimization algorithm.
(5) Performance of a model on the validation set is evaluated. An accuracy rate and a loss of the model are monitored to prevent overfitting. The model is tested with an unseen dataset to evaluate metrics including accuracy, a recall rate, and an F1-score. A parameter of the model is adjusted according to the metrics, thereby obtaining a well-trained ResNet.
(6) The well-trained ResNet is deployed to an actual application, and the notch of the Charpy impact specimen is inspected with the ResNet.

The image recognizing and computing module is configured to recognize the specimen notch picture captured by the autofocus high-definition camera 4, and determine whether a position of the notch in the picture is offset. If yes, the cross-shaped electric sliding rail 6 is controlled by the PLC unit, with the sliding end 601 adjusting a front position, a rear position, a left position and a right position of the specimen placement table 5, thereby adjusting the Charpy impact specimen to align the Charpy impact specimen. Such an adjustment manner prevents the shortage that the former notch projector needs to adjust the specimen manually back and forth, and the objective lens is focused manually.

The embodiment further provides a use method of a Charpy impact specimen notch inspector, including the following steps:
S1: A to-be-inspected Charpy impact specimen is positioned horizontally on a top of a specimen placement table 5.
S2: A host 3 is powered on through a switch button 302, a capturing function is tapped on a touchscreen 301, and an autofocus high-definition camera 4 is activated through a PLC unit to compare a notch picture of the Charpy impact specimen on the top of the specimen placement table 5.
S3: The notch picture of the Charpy impact specimen captured in Step S2 is stored to an image storage module, and an image data preprocessing module performs data preprocessing of noise reduction and filtering on a picture stored in the image storage module, and further performs brightness adjustment and contrast enhancement, thereby improving an image resolution.
S4: An image recognizing and computing module recognizes a picture processed in Step S3, and computes an offset for the notch of the Charpy impact specimen in the picture through an offset computing formula, to determine an offset condition of the Charpy impact specimen, specifically:
S401: A feature of an image in the processed picture is extracted through a well-trained ResNet, and a feature point in the image is recognized through an image processing algorithm. The feature point includes an edge and a midpoint of the notch.
S402: A present position coordinate of the notch is computed through a detected key point, a key position coordinate of a standard notch image is predefined, and a measured coordinate is compared with a standard notch coordinate to obtain the offset. The offset is computed by: {offset}=(x1-x2, y1-y2),
where x1 represents a coordinate value of an actual measured position of a notch extracted by the image recognizing and computing module from a present captured specimen image on a horizontal axis (x-axis), y1 represents a coordinate value of the actual measured position of the notch extracted by the image recognizing and computing module from the present captured specimen image on a vertical axis (y-axis), x2 represents a coordinate value of a preset standard notch position on the horizontal axis (x-axis), y2 represents a coordinate value of the preset standard notch position on the vertical axis (y-axis), and {offset} represents a degree of offset of a present measured notch position relative to the standard position.
S403: A reasonable offset threshold is set as {threshold}={(x_{\{threshold})\hat{ }2+(y_{threshold})\hat{ }2}, an absolute value of a computed offset {offset} is compared with the threshold, and if {offset}>{threshold}, it is determined that a position of the specimen is offset, otherwise, the position of the specimen is not offset.

For example, the standard position is set as (x1, y1)=(100,150).

The measured position of the captured image is (X2, y2)=(105,148).

{Offset}=(105-100, 148-150)=(5, −2), indicating that the present measured position is offset by 5 units on the x-axis and −2 units on the y axis relative to the standard position. The absolute value of the offset is {offset}|={(5)\hat{ }2+(−2)\hat{ }2}={25+4}={29}\approx 5.39]. Supposing that the threshold is 6, {offset}(5.39)<{threshold} (6) means that the captured image is not offset.

If the Charpy impact specimen is offset, a cross-shaped electric sliding rail 6 and a brake motor 7 are controlled through the PLC unit according to the computed offset to drive the specimen placement table 5 for front-back and left-right movement and 360° rotation, such that the specimen placement table 5 drives the Charpy impact specimen on the top of the specimen placement table to move to a preset standard coordinate position.
S5: After the Charpy impact specimen is aligned, a to-be-compared standard model is selected in the image processing module through the touchscreen 301. The standard model is any one of a GB-compliant V&U-notch standard template and an ASTM-compliant V&U-notch standard template.
S6: The image processing module compares the notch picture of the Charpy impact specimen with a selected standard model based on the well-trained ResNet, computes a similarity to determine whether the notch is qualified, and displays a result on the touchscreen 301, thereby completing a work cycle for inspecting the notch of the Charpy impact specimen.

In Step S6 of the embodiment, the step that the image processing module compares the notch picture of the Charpy impact specimen with the selected standard model based on the well-trained ResNet, to determine whether the notch is qualified specifically includes:
S601: Picture data processed by the image data preprocessing module is input to the well-trained ResNet.
S602: A feature of the notch picture in the picture data input in Step S601 is extracted through the ResNet.
S603: The feature extracted in Step S602 is compared with a feature of the standard model by computing the similarity, and whether the notch is qualified is output through the ResNet.

The similarity is computed with a cosine similarity by:

$$[ \{ cosine\_similarity \} ( A , B ) = \{ A ∖ cdot B \} \{ \vert A \vert \vert B \vert \} = \{ ∖ sum\_ \{ i = 1 \} \hat{} \{ n \} A\_i B\_i \} \text{} \{ \{ ∖ sum\_ \{ i = 1 \} \hat{} \{ n \} A\_i \hat{} 2 \} \{ ∖ sum\_ \{ i = 1 \} \hat{} \{ n \} B\_i \hat{} 2 \} \} ] ,$$

where A and B are respectively two eigenvectors to be compared, A\cdotB is a dot product of the two eigenvectors, |A| and |B| are respectively norms of the eigenvectors, an output value of the cosine similarity is between −1 and 1, and a value closer to 1 indicates a higher similarity between the two eigenvectors.

For example, the feature (A) of the notch picture is [A=[0.1, 0.5, 0.3, 0.7, 0.2], while the feature (B) of the standard model is [B=[0.2, 0.4, 0.3, 0.6, 0.1]].

The dot product is computed with a cosine similarity formula:

$$[ A ∖ cdotB = ( 0.1 * 0.2 ) + ( 0.5 * 0.4 ) + ( 0.3 * 0.3 ) + ( 0.7 * 0.6 ) + ( 0.2 * 0.1 ) ] [ = 0.02 + 0.2 + 0.09 + 0.42 + 0.02 = 0.75 ] .$$

The norms |A| and |B| are computed:

$$[ \vert A \vert = \{ ( 0.1 \hat{} 2 ) + ( 0.5 \hat{} 2 ) + ( 0.3 \hat{} 2 ) + ( 0.7 \hat{} 2 ) + ( 0.2 \hat{} 2 ) \} = \{ 0.01 + 025 + 0.09 + 0.49 + 0.04 \} = \{ 0.88 \} ∖ approx 0.93 ] ;$$

$$[ \vert B \vert = \{ ( 0.2 \hat{} 2 ) + ( 0.4 \hat{} 2 ) + ( 0.3 \hat{} 2 ) + ( 0.6 \hat{} 2 ) + ( 0.1 \hat{} 2 ) \} = \{ 0.04 + 0.16 + 0.09 + 0.36 + 0.01 \} = \{ 0.66 \} ∖ approx 0.81 ] .$$

The cosine similarity is computed:

$$\{ cosine\_similarity \} ( A , B ) = \{ 0.75 \} \{ ( 0.93 * 0.81 ) \} ∖ approx \{ 0.75 \} \{ 0.7533 \} ∖ approx 0.99 5 .$$

The computed result is 0.995. Since the value close to 1 indicates that the notch picture in the picture data is very similar to the standard model, the output result is qualified.

The embodiment can automatically recognize and align the position of the to-be-inspected Charpy impact specimen, without adjusting the Charpy impact specimen back and forth, thereby improving the inspection efficiency. Moreover, it can directly compare the notch picture of the Charpy impact specimen with the corresponding standard model based on the ResNet in inspection to determine whether the notch is qualified. Such a direct selecting and comparing method can meet different notch inspection requirements, without frequently changing the standard notch template, thereby omitting the operating steps, and further improving the inspection efficiency.

The above are merely preferred specific implementation of the present disclosure, but the protection scope of the present disclosure is not limited thereto. Any equivalent replacement or modification made by a person skilled in the art according to the technical solutions of the present disclosure and inventive concepts thereof within the technical scope of the present disclosure shall fall within the protection scope of the present disclosure.

What is claimed is:

1. A Charpy impact specimen notch inspector, comprising an inspection table (1), wherein a specimen auto-alignment mechanism is provided on a top of the inspection table (1); a support rod (2) is fixedly connected to a rear side of the top of the inspection table (1); a host (3) is fixedly connected to a front side of the support rod (2); a switch button (302) and a universal serial bus (USB) interface (303) are provided at a left side of the host (3); a touchscreen (301) is provided on a top of the host (3); and an autofocus high-definition camera (4) is fixedly provided at a bottom of the host (3); and
the host (3) comprises an image data preprocessing module, an image storage module, an image processing module, an image recognizing and computing module, a programmable logic controller (PLC) unit, and a battery module; the image storage module is connected to the autofocus high-definition camera (4), the USB interface (303), and the image data preprocessing module; the image data preprocessing module is connected to the image processing module and the image recognizing and computing module; the PLC unit is connected to the image recognizing and computing module and the autofocus high-definition camera (4); and the image processing module is connected to the touchscreen (301).

2. The Charpy impact specimen notch inspector according to claim 1, wherein the specimen auto-alignment mechanism comprises a specimen placement table (5) in movable contact with the top of the inspection table (1); a mounting groove (101) is formed in the top of the inspection table (1); a cross-shaped electric sliding rail (6) is fixedly connected to a bottom inner wall of the mounting groove (101); a brake motor (7) is fixedly connected to a top of a sliding end (601) of the cross-shaped electric sliding rail (6); a top end of an output shaft of the brake motor (7) is fixedly connected to a bottom of the specimen placement table (5); and both the cross-shaped electric sliding rail (6) and the brake motor (7) are electrically connected to the PLC unit.

3. The Charpy impact specimen notch inspector according to claim 1, wherein the battery module is configured to supply power to the host (3); the autofocus high-definition camera (4) is configured to compare a picture of a notch of a Charpy impact specimen, with a captured notch picture stored by the image storage module; and the image data preprocessing module is configured to perform data preprocessing of noise reduction and filtering on the stored notch picture, and further configured to perform brightness adjustment and contrast enhancement, thereby improving an image resolution.

4. The Charpy impact specimen notch inspector according to claim 1, wherein a Guobiao (GB, Chinese national standard)-compliant V&U-notch standard template and an American Society for Testing Material (ASTM)-compliant V&U-notch standard template are stored in the image processing module; a desired standard model is able to be selected through the touchscreen; and the image processing module is configured to compare a picture of a notch captured by the autofocus high-definition camera (4) with the selected standard model using a residual neural network (ResNet) to determine whether the notch is qualified; and
the ResNet needs to be trained in advance to form a network, with an accuracy determined by a test set; and the ResNet is formed specifically as follows:
(1) acquiring Charpy impact specimen images in different states, comprising a notched sample, an unnotched sample, and samples with different notch types and sizes, labeling each specimen image with a notch state and a corresponding class, adjusting the specimen image to a uniform size to meet an input requirement of a common ResNet, scaling a pixel value to an interval [0, 1], and expanding a dataset with data augmentation;
(2) partitioning an expanded dataset into a training set (70%), a validation set (15%), and the test set (15%), and ensuring that samples in each set are sufficient and representative;
(3) according to a sample complexity and a computing resource, selecting an appropriate version of ResNet, constructing a network comprising a plurality of residual blocks, each residual block comprising a convolutional layer, batch normalization, and a rectified linear unit (ReLU) activation function; and setting an initial value for a weight of the network with a He initialization method;
(4) inputting the samples in the training set to the appropriate version of ResNet, computing an output, computing a loss according to an output result and a ground truth label, computing a gradient of the loss on each parameter with a back propagation algorithm, and updating the weight with an optimization algorithm;
(5) evaluating performance of a model on the validation set, monitoring an accuracy rate and a loss of the model to prevent overfitting, testing the model with an unseen dataset to evaluate metrics comprising an accuracy, a recall rate, and an F1-score, and adjusting a parameter of the model according to the metrics, thereby obtaining a well-trained ResNet; and
(6) deploying the well-trained ResNet to an actual application, and inspecting the notch of the Charpy impact specimen with the ResNet.

5. The Charpy impact specimen notch inspector according to claim 2, wherein the image recognizing and computing module is configured to recognize the specimen notch picture captured by the autofocus high-definition camera (4), and determine whether a position of the notch in the picture is offset; and if yes, the cross-shaped electric sliding rail (6) is controlled by the PLC unit, with the sliding end (601) adjusting a front position, a rear position, a left position and a right position of the specimen placement table (5).

6. The Charpy impact specimen notch inspector according to claim 1, wherein the USB interface (303) is connected to an external storage device, and configured to transmit data stored in the image storage module to the external storage device.

7. A use method of a Charpy impact specimen notch inspector, comprising the following steps:
S1: positioning a to-be-inspected Charpy impact specimen horizontally on a top of a specimen placement table (5);
S2: powering on a host (3) through a switch button (302), tapping a capturing function on a touchscreen (301), and activating an autofocus high-definition camera (4) through a programmable logic controller (PLC) unit to compare a notch picture of the Charpy impact specimen on the top of the specimen placement table (5);
S3: storing the notch picture of the Charpy impact specimen captured in the step S2 to an image storage module, and performing, by an image data preprocessing module, data preprocessing of noise reduction and filtering on a picture stored in the image storage module, and further performing brightness adjustment and contrast enhancement, thereby improving an image resolution;
S4: recognizing, by an image recognizing and computing module, a picture processed in the step S3, and computing an offset for the notch of the Charpy impact specimen in the picture through an offset computing formula, to determine an offset condition of the Charpy impact specimen; and if the Charpy impact specimen is offset, controlling a cross-shaped electric sliding rail (6) and a brake motor (7) through the PLC unit according to the computed offset to drive the specimen placement table (5) for front-back and left-right movement and 360° rotation, such that the specimen placement table (5) drives the Charpy impact specimen on the top of the specimen placement table (5) to move to a preset standard coordinate position;
S5: after the Charpy impact specimen is aligned, selecting a to-be-compared standard model in an image processing module through the touchscreen (301), wherein the standard model is any one of a Guobiao (GB, Chinese national standard)-compliant V&U-notch standard template and an American Society for Testing Material (ASTM)-compliant V&U-notch standard template; and
S6: comparing, by the image processing module, the notch picture of the Charpy impact specimen with a selected standard model using a well-trained residual neural network (ResNet), computing a similarity to determine whether a notch is qualified, and displaying a result on the touchscreen (301), thereby completing a work cycle for inspecting the notch of the Charpy impact specimen.

8. The use method of a Charpy impact specimen notch inspector according to claim 7, wherein in the step S4, computing the offset for the notch of the Charpy impact specimen in the picture through the offset computing formula, to determine the offset condition of the Charpy impact specimen specifically comprises:
S401: extracting a feature of an image in the processed picture through the well-trained ResNet, and recognizing a feature point in the image through an image processing algorithm, the feature point comprising an edge and a midpoint of the notch;
S402: computing a present position coordinate of the notch through a detected key point, predefining a key position coordinate of a standard notch image, and comparing a measured coordinate with a standard notch coordinate to obtain the offset, wherein the offset is computed by: {offset}=(x1-x2, y1-y2),
wherein x1 represents a coordinate value of an actual measured position of the notch extracted by the image recognizing and computing module from a present captured specimen image on a horizontal axis (x-axis), y1 represents a coordinate value of the actual measured position of the notch extracted by the image recognizing and computing module from the present captured specimen image on a vertical axis (y-axis), x2 represents a coordinate value of a preset standard notch position on the horizontal axis (x-axis), y2 represents a coordinate value of the preset standard notch position on the vertical axis (y-axis), and {offset} represents a degree of offset of a present measured notch position relative to the standard position; and
S403: setting a reasonable offset threshold as {threshold}={(x_{\{threshold})\hat{ }2+(y_{threshold})\hat{ }2}, comparing an absolute value of a computed offset {offset} with the threshold, and if {offset}>{threshold}, determining that a position of the specimen is offset, otherwise, the position of the specimen is not offset.

9. The use method of a Charpy impact specimen notch inspector according to claim 7,
wherein in the step S6, comparing, by the image processing module, the notch picture of the Charpy impact specimen with the selected standard model based on the well-trained ResNet, to determine whether the notch is qualified specifically comprises:
S601: inputting picture data processed by the image data preprocessing module to the well-trained ResNet;
S602: extracting, through the ResNet, a feature of the notch picture in the picture data input in the step S601; and
S603: comparing the feature extracted in the step S602 with a feature of the standard model by computing the similarity, and outputting, through the ResNet, whether the notch is qualified, wherein
the similarity is computed with a cosine similarity by:
$$[ \{ cosine\_similarity \} ( A , B ) = \{ A ∖ cdot B \} \{ \vert A \vert \vert B \vert \} = \{ ∖ sum\_ \{ i = 1 \} \hat{} \{ n \} A\_i B\_i \} \text{} \{ \{ ∖ sum\_ \{ i = 1 \} \hat{} \{ n \} A\_i \hat{} 2 \} \{ ∖ sum\_ \{ i = 1 \} \hat{} \{ n \} B\_i \hat{} 2 \} \} ] ,$$
wherein A and B are respectively two eigenvectors to be compared, A\cdotB is a dot product of the two eigenvectors, |A| and |B| are respectively norms of the eigenvectors, an output value of the cosine similarity is between −1 and 1, and a value closer to 1 indicates a higher similarity between the two eigenvectors.
